(19) United States
(12) Patent Application Publication
(10) Pub. No.: US 2024/0279103 A1
(43) Pub. Date: Aug. 22, 2024

(54) CRYSTALLIZED GLASS, CRYSTALLIZED GLASS OF THREE-DIMENSIONAL SHAPE, AND PRODUCTION METHOD THEREFOR

(71) Applicant: AGC Inc., Tokyo (JP)

(72) Inventors: Takanori FUKUSHI, Tokyo (JP); Mizuki MATSUOKA, Tokyo (JP); Hiroshi KOMATSU, Tokyo (JP); Satoshi KANASUGI, Tokyo (JP)

(73) Assignee: AGC Inc., Tokyo (JP)

(21) Appl. No.: 18/652,972

(22) Filed: May 2, 2024

Related U.S. Application Data
(63) Continuation of application No. PCT/JP2022/046552, filed on Dec. 16, 2022.

(30) Foreign Application Priority Data
Dec. 17, 2021 (JP) 2021-205528

(51) Int. Cl. C03B 23/03; C03C 10/00; C03C 21/00

(52) U.S. Cl. CPC C03B 23/03; C03C 10/00; C03C 10/0027; C03C 10/0054; C03C 21/002

(57) ABSTRACT

The present invention relates to a glass ceramic having a three-dimensional shape including a plurality of round shapes including a minimum round shape having an average curvature radius of 5.0×10² mm or less and a maximum round shape having an average curvature radius of 1.0×10³ mm or more, in which the glass ceramic has a sheet thickness t [mm], and a value obtained by dividing a maximum value of retardation [nm] measured by the following measurement method by the sheet thickness t [mm] is 50 [nm/mm] or less, measurement method: retardation is measured using a birefringence measuring device by vertically irradiating one or more points on an arc of each of the round shapes with light having a wavelength of 543 nm.

### TECHNICAL FIELD

The present invention relates to a glass ceramic suitable for a glass, particularly a cover glass, a glass ceramic having a three-dimensional shape, and a production method therefor.

### BACKGROUND ART

A cover glass of a display device of a mobile device such as a mobile phone or a smart phone, and a cover glass of an in-vehicle display member such as an instrument panel or a head up display (HUD) are required to have excellent strength and transparency. As such a cover glass, for example, a chemically strengthened glass, which is thin and has a high strength, is used.

As a glass used for the cover glass, a glass having a three-dimensional shape constituted by a plurality of round shapes may be required in order to improve operability and visibility. Examples of methods for producing the glass having a three-dimensional shape include a method in which a flat glass sheet is heated and pressed using a mold to perform bending (also referred to as three-dimensional molding) (Patent Literature 1).

As the glass used for the cover glass, an amorphous glass containing no crystals is used, but a glass ceramic having a higher strength is also proposed (Patent Literature 2). The glass ceramic is a glass in which crystals are precipitated in the glass by heat treatment of the glass.

### CITATION LIST

### Patent Literature

Patent Literature 1: WO2014/167894
Patent Literature 2: WO2019/022034

### SUMMARY OF INVENTION

### Technical Problem

In a method of producing a glass having a three-dimensional shape by bending as in Patent Literature 1, particularly in a curved portion, heat unevenness occurs during heating due to contact unevenness between a glass and a mold, and an internal stress (hereinafter, also referred to as retardation) easily occurs in the glass after molding.

When the retardation in the glass increases, cracking at the time of annealing of the glass, cracking at the time of assembling a housing, and cracking due to stress concentration at the time of dropping are likely to occur, and there is a problem that yields and productivity are significantly deteriorated. In addition, as the retardation in the glass increases, distortion of the three-dimensionally shaped glass is likely to occur, and there is a problem that optical quality or the like is deteriorated.

In the related art, in a method of producing a glass having a three-dimensional shape by bending a glass ceramic, it has been considered that when an equilibrium viscosity of a glass is made to be the same, an adhesive strength between the glass and a mold is the same, and a molded product having the same quality can be obtained. However, in reality, the adhesive strength varies depending on a glass material, and it is difficult to obtain a molded product having the same quality.

Therefore, an object of the present invention is to provide a three-dimensionally shaped glass ceramic having excellent yields and productivity and reduced distortion, and a production method therefor.

### Solution to Problem

As a result of studies on the above problems, the present inventors have found that, in a glass ceramic having a three-dimensional shape obtained by bending a glass ceramic, retardation is likely to increase particularly in a bent portion, and when a value obtained by dividing a maximum value of the retardation by a sheet thickness increases, cracking and distortion are likely to occur. Further, the present inventors have found that, by adjusting the value, the cracking and the distortion in the glass ceramic having a three-dimensional shape can be prevented, and have made a first invention.

In addition, the present inventors have found that when the glass ceramic having a three-dimensional shape is produced by bending the glass ceramic, the retardation can be made smaller by adjusting an adhesive strength between the glass ceramic and a mold in a high-temperature field, and have made a second invention.

The first invention relates to a glass ceramic having a three-dimensional shape including a plurality of round shapes including a minimum round shape having an average curvature radius of 5.0×10² mm or less and a maximum round shape having an average curvature radius of 1.0×10³ mm or more, in which
the glass ceramic has a sheet thickness t [mm], and a value obtained by dividing a maximum value of retardation [nm] measured by the following measurement method by the sheet thickness t [mm] is 50 [nm/mm] or less,
measurement method: retardation is measured using a birefringence measuring device by vertically irradiating one or more points on an arc of each of the round shapes with light having a wavelength of 543 nm.

The second invention relates to a glass ceramic, in which
an adhesive strength with a carbon member is 140 [N] or less, where the adhesive strength is measured by the following method when an equilibrium viscosity of the glass ceramic is 1.0×10⁹ [dPa·S],

### (Measurement Method)

the glass ceramic is heated from room temperature to a set temperature at 100° C./min, allowed to stand for 10 minutes after reaching the set temperature, and the carbon member below is pressed at 32 N on the glass ceramic and then held for 180 seconds; thereafter, an adhesive force generated when the carbon member is pulled up from the glass ceramic at 10 mm/min is measured by a load cell, and is defined as an adhesive strength,
measuring device: light-condensing heating-type high-temperature observation tensile and compression tester,
size of glass ceramic: 9.2× 9.2× 2 [mm],
carbon member: CIP (Cold Isostatic Pressing) carbon,
diameter of contact surface of carbon member with glass ceramic: diameter 9 [mm],
roughness of contact surface of carbon member with glass ceramic: arithmetic average roughness Ra in accordance with JIS B0601 (2013) is 1.1 [μm], and arithmetic average waviness Wa is 0.08 [μm],
oxygen concentration during measurement: 100 [ppm] or less,
the set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

This invention relates to a method for producing a glass ceramic having a three-dimensional shape, the method including:
press molding a glass ceramic with a mold, in which
the glass ceramic has an adhesive strength with a carbon member of 140 [N] or less, where the adhesive strength is measured by the following method when an equilibrium viscosity of the glass ceramic is 1.0×10⁹ [dPa·S],

### (Measurement Method)

the glass ceramic is heated from room temperature to a set temperature at 100° C./min, allowed to stand for 10 minutes after reaching the set temperature, and the carbon member below is pressed at 32 N on the glass ceramic and then held for 180 seconds; thereafter, an adhesive force generated when the carbon member is pulled up from the glass ceramic at 10 mm/min is measured by a load cell, and is defined as an adhesive strength,
measuring device: light-condensing heating-type high-temperature observation tensile and compression tester,
size of glass ceramic: 9.2× 9.2×2 [mm],
carbon member: CIP carbon,
diameter of contact surface of carbon member with glass ceramic: diameter 9 [mm],
roughness of contact surface of carbon member with glass ceramic: arithmetic average roughness Ra in accordance with JIS B0601 (2013) is 1.1 [μm], and arithmetic average waviness Wa is 0.08 [μm],
oxygen concentration during measurement: 100 [ppm] or less,
the set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

### Advantageous Effects of Invention

In the glass ceramic having a three-dimensional shape according to the first invention, the value obtained by dividing the maximum value of the retardation by the sheet thickness is within a specific range, and thus cracking and distortion in the glass having a three-dimensional shape are prevented, and yields and productivity are excellent.

In the glass ceramic according to the second invention, an adhesive strength with a mold is within a specific range, and thus releasability from the mold can be improved, and retardation in a glass having a three-dimensional shape can be reduced. Accordingly, cracking and distortion in the glass having a three-dimensional shape can be prevented, and yields and productivity are excellent.

In the method for producing the glass ceramic having a three-dimensional shape according to this invention, an adhesive strength between a mold used for press molding and the glass ceramic is within a specific range, and thus a glass ceramic having a three-dimensional shape in which retardation is small and cracking and distortion are prevented can be produced with excellent yields and productivity.

### BRIEF DESCRIPTION OF DRAWINGS

FIG. 1 is a perspective view showing an example of a shape of a three-dimensionally shaped glass of the present invention.

FIGS. 2A and 2B are views showing an example of the shape of the three-dimensionally shaped glass of the present invention, in which FIG. 2A is a front view, and FIG. 2B is a perspective view.

FIGS. 3A and 3B are views showing an example of the shape of the three-dimensionally shaped glass of the present invention, in which FIG. 3A is a front view, and FIG. 3B is a perspective view.

FIG. 4 is a schematic diagram illustrating a method of measuring an adhesive strength between a glass ceramic and a carbon member.

FIG. 5 is a diagram showing results of measuring the adhesive strength between the glass ceramic and the carbon member by changing an equilibrium viscosity of the glass ceramic.

FIG. 6 shows results of measuring retardation of the glass ceramic.

FIG. 7 is a schematic diagram showing a correspondence relationship between measurement points of a curvature radius in the three-dimensionally shaped glass ceramic.

### DESCRIPTION OF EMBODIMENTS

In the present description, “to” indicating a numerical range is used in the sense of including the numerical values set forth before and after the “to” as a lower limit value and an upper limit value. Unless otherwise specified, “to” in the present description is used hereinafter in the same meaning as described above.

Among carbon members in the present description, a carbon member used for measuring an adhesive strength is MC 4333 manufactured by Mechanical Carbon Industry Co., Ltd., and a carbon member used as a mold is ET-10 manufactured by IBIDEN CO., LTD.

In the present description, an “amorphous glass” and a “glass ceramic” are collectively referred to as a “glass”. In the present description, the “amorphous glass” refers to a glass in which a diffraction peak indicating a crystal is not observed by powder X-ray diffraction. The “glass ceramic” refers to a glass obtained by subjecting the “amorphous glass” to a heat treatment to precipitate crystals, and contains crystals.

In the powder X-ray diffraction measurement, measurement is performed in a range of 20 of 10° to 80° using a CuKα ray, and when a diffraction peak appears, the precipitated crystal is identified by, for example, Hanawalt method.

In the following, a “chemically strengthened glass” refers to a glass after being subjected to a chemical strengthening treatment. A “base composition of the chemically strengthened glass” refers to a glass composition of a glass for chemical strengthening. A glass composition of a portion deeper than a compressive stress layer depth (DOL) of the chemically strengthened glass is the base composition of the chemically strengthened glass except for a case where an extreme ion exchange treatment is performed.

In the present description, a glass composition is expressed in terms of mass % based on oxides unless otherwise specified, and mass % is simply expressed as “%”.

In the present description, “not substantially contained” means that a component has a content equal to or less than an impurity level contained in raw materials and the like, that is, the component is not intentionally added. In the present description, when it is described that a certain component is not substantially contained, a content of the component is specifically, for example, less than 0.1%.

In the present description, a “stress profile” represents a compressive stress value with a depth from a glass surface as a variable. In the stress profile, a tensile stress is expressed as a negative compressive stress.

A “compressive stress value (CS)” or a “surface compressive stress value (CS₀)” can be measured by thinning a cross section of a glass and analyzing the thinned sample with a birefringence imaging system. Examples of the birefringence imaging system include a birefringence imaging system Abrio-IM manufactured by Tokyo Instruments Inc. In addition, the “compressive stress value (CS)” or the “surface compressive stress value (CS₀)” can also be measured using scattered light photoelasticity. In the method, light is incident from a surface of the glass, and polarization of scattered light thereof is analyzed to measure CS. Examples of a stress measuring instrument using the scattered light photoelasticity include a scattered light photoelasticity stress meter SLP-1000 manufactured by Orihara Manufacturing Co., Ltd.

In the present description, the “compressive stress layer depth (DOL)” refers to a depth at which the compressive stress value (CS) is zero. In the present description, an “internal tensile stress (CT)” refers to a tensile stress value at a depth of ½ of a sheet thickness t.

In the present description, “retardation” refers to a value that is measured using a birefringence meter by irradiating a main surface of a glass sheet with light having a wavelength of 543 nm from a direction perpendicular to the main surface, and is converted to a thickness of 0.55 mm. Examples of the birefringence meter include WPA-100 and WPA-200 manufactured by Photonic Lattice, Inc.

In the present description, a “light transmittance” refers to an average transmittance of visible light having a wavelength of 380 nm to 780 nm. A “haze value” refers to a value measured in accordance with JIS K3761:2000 using a C light source. A “haze value in terms of a thickness of 0.8 mm” refers to a haze value measured by processing such that a thickness of a measurement target becomes 0.8 mm when the thickness is not 0.8 mm. Alternatively, the “haze value in terms of a thickness of 0.8 mm” refers to a haze value that corresponds to a case of a thickness of 0.8 mm and that is obtained by calculation from a haze value measured at an original thickness and a haze value measured after the thickness is changed by processing.

In the present description, a “thermal expansion coefficient” refers to an average thermal expansion coefficient from 50° C. to 500° C., unless otherwise specified, measured at a heating rate of 10° C./min in accordance with JIS R1618:2002. A “glass transition point” refers to a value obtained from a thermal expansion curve.

In the present description, “Vickers hardness” refers to Vickers hardness (HV0.1) defined in JIS R1610:2003.

A “fracture toughness value” can be measured using a DCDC method (Acta metall. mater. Vol. 43, pp. 3453-3458, 1995).

### <Three-Dimensionally Shaped Glass>

A three-dimensionally shaped glass according to the present invention includes a glass ceramic having a three-dimensional shape and a chemically strengthened glass having a three-dimensional shape. In the present invention, the “three-dimensional shape” refers to a shape including a plurality of round shapes including a minimum round shape having an average curvature radius of 5.0×10² mm or less and a maximum round shape having an average curvature radius of 1.0×10³ mm or more. Hereinafter, the minimum round shape having an average curvature radius of 5.0×10² mm or less is also abbreviated as a “bent portion”, and the maximum round shape having an average curvature radius of 1.0×10³ mm or more is also abbreviated as a “flat portion”.

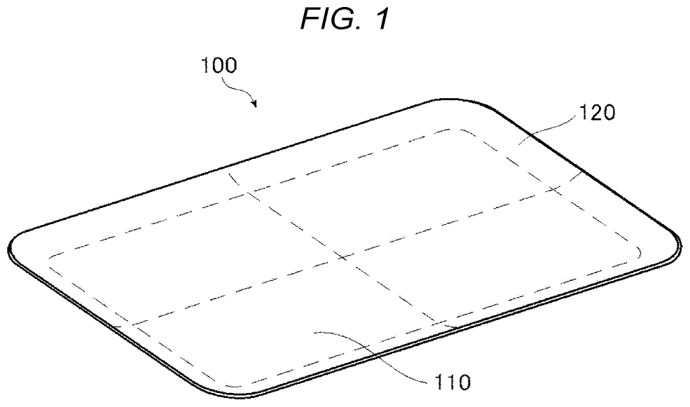

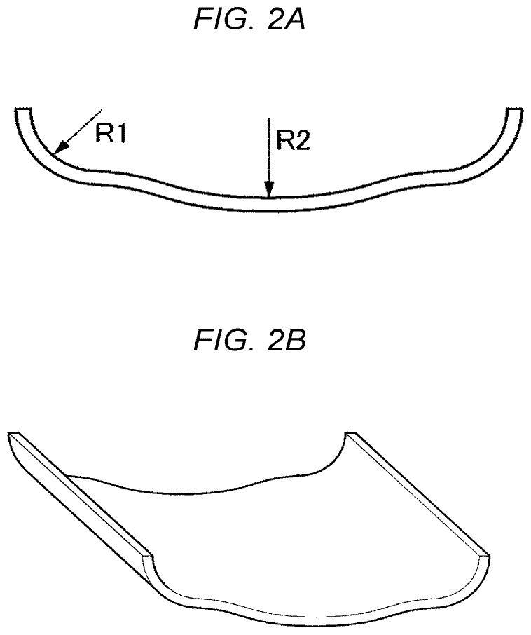

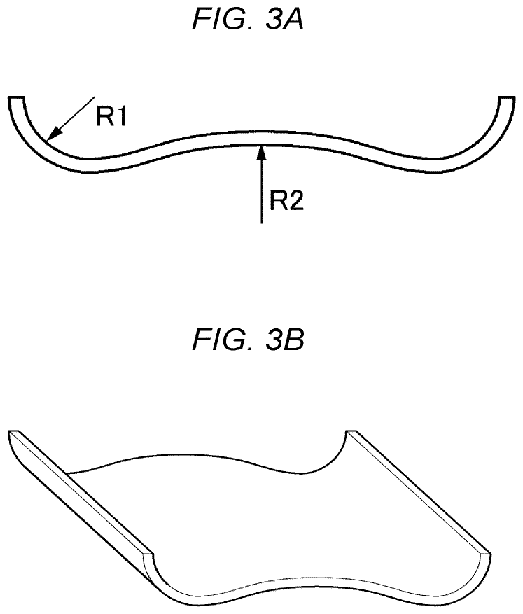

The three-dimensional shape in the present invention includes any of a curved shape formed of a continuous curve, a shape curved in vertical and horizontal directions, and a shape having unevenness on a plane. FIG. 1, FIG. 2A, FIG. 2B, FIG. 3A and FIG. 3B are views each showing an example of the three-dimensionally shaped glass of the present invention. Although the drawing shows a three-dimensionally shaped glass having a uniform thickness as a whole, the three-dimensional shape may be a shape having portions having different thicknesses.

A three-dimensionally shaped glass 100 of FIG. 1 has a peripheral portion 120 around a central portion 110 which is substantially flat, includes a minimum round shape between the central portion 110 and the peripheral portion 120, and includes a maximum round shape in the central portion 110 which is substantially flat.

In FIGS. 2A and 2B, a glass is shown that has a shape including, at both ends of an inner and back surface, a pair of minimum round shapes having an average curvature radius R1 and curved in a direction away from an outer surface toward both ends, and including a maximum round shape having an average curvature radius R2 and curved upward (in the drawing).

In FIGS. 3A and 3B, a glass is shown that has a shape including, at both ends of an inner and back surface, a pair of minimum round shapes having an average curvature radius R1 and curved in a direction away from an outer surface toward both ends, and including a maximum round shape having an average curvature radius R2 and curved downward (in the drawing).

An average curvature is a physical index value indicating how a surface deviates from a plane. The mathematical derivation of the average curvature is well known, and is omitted in the present description. In brief, an average curvature of a surface is determined as an intermediate value between a maximum value and a minimum value of a curvature of a rotating body obtained by rotating a curved surface around a normal vector of the curved surface at a certain point on the surface. In addition, an average curvature radius of the surface is determined as a reciprocal of the average curvature.

As a specific example, an average curvature at any point on a spherical surface of a sphere having a radius R is 1/R. At any point on a side surface of a cylinder having a radius of a bottom surface R, a maximum curvature is 1/R and a minimum curvature is 0, and thus an average curvature is ½R. Therefore, a value of an average curvature at a certain point on a surface is an important parameter representing a physical shape. The average curvature can be measured by any known method.

An average curvature radius R1 of the minimum round shape is 5.0×10² mm or less, preferably 1.0×10² mm or less, and more preferably 5.0×10¹ mm or less. In addition, the average curvature radius R1 is preferably 1.0 mm or more, more preferably 2.5 mm or more, and still more preferably 5.0 mm or more. A bending angle of the minimum round shape is preferably 1° or more, more preferably 10° or more, and still more preferably 20° or more. In addition, the bending angle of the minimum round shape is preferably 89º or less, more preferably 80° or less, and still more preferably 75° or less.

An average curvature radius R2 of the maximum round shape is 1.0×10³ mm or more, preferably 2.5×10³ mm or more, and more preferably 5.0×10³ mm or more. In addition, the average curvature radius R2 is preferably 4.0×10⁵ mm or less, more preferably 2.0×10⁵ mm or less, and still more preferably 1.0×10⁵ mm or less. A bending angle of the maximum round shape is preferably more than 0° to 10.0°, more preferably more than 0° to 8.0°, and still more preferably more than 0° to 5.0°.

A stress remaining inside the three-dimensionally shaped glass according to the present invention can be evaluated using retardation as an index. For example, a refractive index difference (refractive index anisotropy) between a refractive index for light of first linearly polarized light having a predetermined wavelength and a refractive index for light of second linearly polarized light orthogonal to the first linearly polarized light, which is measured using a birefringence measuring device, is represented by Δn, and a thickness of the central portion of the three-dimensionally shaped glass is represented by t [nm].

At this time, a level of the residual stress may be evaluated based on measured retardation Δn×t [nm]. In addition, the retardation is not limited to a case where an actual thickness (t [nm]) of the central portion of the three-dimensionally shaped glass is used as it is, and the level may be evaluated as retardation Δn×d [nm/mm] per 1 mm thickness. In this case, calculation can be performed using d=t [nm]/t [mm].

In the three-dimensionally shaped glass of the present embodiment, a haze value in terms of a thickness of 0.8 mm of the maximum round shape is preferably 1.0% or less, more preferably 0.8% or less, and still more preferably 0.5% or less. When the haze value is 1.0% or less, excellent transparency can be realized, and the three-dimensionally shaped glass is suitable for a cover glass or the like of a display unit of a mobile terminal or the like.

On the other hand, in a case where it is difficult to reduce the haze without lowering a crystallization rate, the haze value in terms of a thickness of 0.8 mm of the maximum round shape is preferably 0.05% or more, and more preferably 0.08% or more, in order to increase a mechanical strength or the like.

In the three-dimensionally shaped glass of the present embodiment, a light transmittance in terms of a thickness of 0.8 mm of the maximum round shape is preferably 85% or more, more preferably 87% or more, still more preferably 88% or more, and particularly preferably 89% or more. When the light transmittance is 85% or more, a screen can be easily seen when the three-dimensionally shaped glass is used as a cover glass of a mobile display. The light transmittance is preferably as high as possible, but is usually 91% or less, or 90% or less. The light transmittance of 91% is equivalent to that of a general amorphous glass.

The three-dimensionally shaped glass of the present embodiment is a glass ceramic, and thus has a higher strength and higher Vickers hardness, as compared with an amorphous glass, so that the three-dimensionally shaped glass is less likely to be damaged. The Vickers hardness is preferably 700 or more, more preferably 740 or more, and still more preferably 780 or more for wear resistance. On the other hand, if the Vickers hardness is too high, processing may become difficult, so that the Vickers hardness is preferably 1100 or less, more preferably 1050 or less, and still more preferably 1000 or less.

Hereinafter, a glass ceramic having a three-dimensional shape according to a first embodiment of the present invention and a glass ceramic according to a second embodiment of the present invention will be described.

### First Embodiment

The first embodiment of the present invention is a glass ceramic having a three-dimensional shape including a plurality of round shapes including a minimum round shape having an average curvature radius of 5.0×10² mm or less and a maximum round shape having an average curvature radius of 1.0×10³ mm or more, in which the glass ceramic has a sheet thickness t [mm], and a value obtained by dividing a maximum value of retardation [nm] measured by the following measurement method by the sheet thickness t [mm] is 50 [nm/mm] or less. Measurement method: retardation is measured using a birefringence measuring device by vertically irradiating one or more points on an arc of each of the round shapes with light having a wavelength of 543 nm. However, when an angle formed by a tangent line of a curved surface at a central portion of a measurement sample and a tangent line of a measurement target surface is 90° or more, the measurement is not performed.

The sheet thickness t in the present embodiment refers to a sheet thickness [mm] at a position where the retardation is measured.

A magnitude of the retardation depends on a stress in the glass. In the present embodiment, when the value obtained by dividing the maximum value of the retardation [nm] by the sheet thickness t [mm] is 50 [nm/mm] or less, it is possible to prevent cracking at the time of annealing, cracking at the time of assembling a housing, and cracking due to stress concentration at the time of dropping. The value obtained by dividing the maximum value of the retardation [nm] by the sheet thickness t [mm] is preferably 50 [nm/mm] or less, more preferably 40 [nm/mm] or less, and still more preferably 35 [nm/mm] or less. A lower limit of the value is not particularly limited, but is usually 5 nm/mm or more.

In the present embodiment, the value obtained by dividing the maximum value of the retardation [nm] by the sheet thickness t [mm] can be adjusted by adjusting an adhesive strength between a mold (carbon member) and the glass ceramic at a high temperature. The adhesive strength can be adjusted by adjusting crystal particles contained in the glass ceramic, a crystallization rate, and an average particle size of precipitated crystals. Specifically, for example, the adhesive strength can be improved by preferably selecting at least one crystal specie of the glass ceramic selected from the group consisting of Li₃PO₄ crystals, Li₄SiO₄ crystals, Li₂SiO₃ crystals, Li₂Mg (Si(4) crystals, LiAlSiO crystals, and Li₂Si₂O₄ crystals. The LiAlSiO crystal is represented by Li₍₁₋ₓ₎Al₍₁₋ₓ₎Si₂O₍₄₊₂₍₁₋ₓ₎.

The carbon member used as the mold is ET-10 manufactured by IBIDEN CO., LTD.

### SECOND EMBODIMENT

The second embodiment of the present invention is a glass ceramic, in which an adhesive strength with a carbon member is 140 [N] or less, where the adhesive strength is measured by the following method when an equilibrium viscosity of the glass ceramic is 1.0×10⁹ [dPa·S].

### (Method)

The glass ceramic is heated from room temperature to a set temperature at 100° C./min, and the following carbon member is pressed at 32 N on the glass ceramic which is allowed to stand for 10 minutes after reaching the set temperature, and then held for 180 seconds. Thereafter, an adhesive force generated when the carbon member is pulled up from the glass ceramic at 10 mm/min is measured by a load cell, and is defined as an adhesive strength.

Measuring device: light-condensing heating-type high-temperature observation tensile and compression tester

Size of glass ceramic: 9.2×9.2×2 [mm]

Carbon member: CIP carbon

Diameter of contact surface of carbon member with glass ceramic: diameter 9 [mm]

Roughness of contact surface of carbon member with glass ceramic: arithmetic average roughness Ra in accordance with JIS B0601 (2013) is 1.1 [μm], and arithmetic average waviness Wa is 0.08 [μm]

Oxygen concentration during measurement: 100 [ppm] or less

The set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

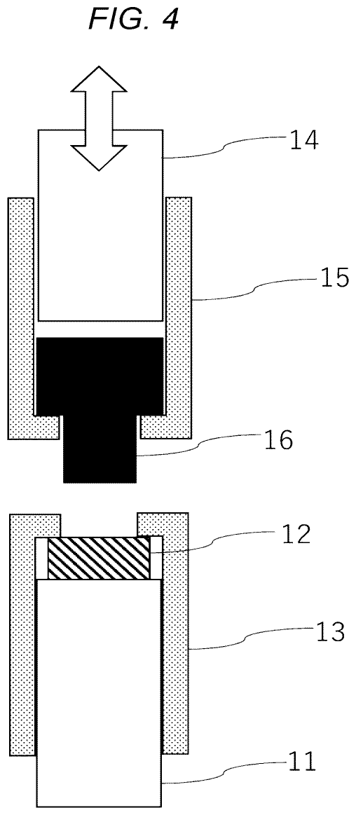

A schematic diagram of the measurement method is shown in FIG. 4. Referring to FIG. 4, the measurement method is as follows. A glass ceramic 12 is placed on a table 11 of a measuring device, and the glass ceramic 12 is fixed with a holder 13. The glass ceramic 12 is heated to a set temperature and then allowed to stand. When a load is applied to a pressing portion 14 from above the glass ceramic 12, a carbon member 16 held by a holder 15 is pressed against the glass ceramic and held, and then an adhesive force generated when the carbon member 16 is pulled up from the glass ceramic 12 is measured by a load cell, and is defined as an adhesive strength. Examples of the load cell include TCL7-100NA (manufactured by Tokyo Measuring Instruments Laboratory Co., Ltd.).

The equilibrium viscosity of the glass is measured, for example, under the following conditions.

Device: WRVM-313 manufactured by OPT Corporation

Sample: Φ10×6 mm

Measurement conditions: at 10° C./min from room temperature to (Tg−50° C.), and a measurement temperature range of 5° C./min

When the adhesive strength is 140 [N] or less, the retardation of the glass having a three-dimensional shape can be reduced, and cracking and distortion can be significantly prevented. It was usually thought that if the equilibrium viscosity of the glass ceramic is the same, the adhesive strength with the mold is the same, but the present inventors have found that the adhesive strength between the glass ceramic and the carbon member varies even when the equilibrium viscosity of the glass ceramic is the same. Based on this finding, the present inventors have found that there is a correlation between the adhesive strength and the retardation of the glass having a three-dimensional shape, and that the retardation can be reduced by setting the adhesive strength to 140 [N] or less.

From the viewpoint of preventing the cracking and the distortion of the three-dimensionally shaped glass, the adhesive strength is preferably 130 [N] or less, more preferably 120 [N] or less, and still more preferably 110 [N] or less. In addition, from the viewpoint of preventing positional displacement at the time of placement on the mold, the adhesive strength is usually preferably 0.01 [N] or more.

In the present embodiment, the adhesive strength can be adjusted by adjusting the crystal particles contained in the glass ceramic, the crystallization rate, and the average particle size of the precipitated crystals. Specifically, for example, the adhesive strength can be improved by preferably selecting at least one crystal specie of the glass ceramic selected from the group consisting of Li₃PO₄ crystals, Li₄SiO₄ crystals, Li₂SiO₃ crystals, Li₂Mg (SiO₄) crystals, LiAlSiO crystals, and Li₂Si₂O₄ crystals.

### <<Glass Ceramic>

The glass ceramic in the present embodiment (hereinafter, also abbreviated as a “present glass ceramic”) preferably contains at least one selected from the group consisting of Li₃PO₄ crystals, Li₄SiO₄ crystals, Li₂SiO₃ crystals, Li₂Mg (SiO₄) crystals, LiAlSiO crystals, and Li₂Si₂O₄ crystals. By using these crystals as a main crystal, it is possible to reduce the adhesive strength with the mold at a high temperature, reduce the retardation in the glass having a three-dimensional shape, and prevent the cracking and the distortion.

The present glass ceramic may contain two or more types of Li₃PO₄ crystal, Li₄SiO₄ crystal, Li₂SiO₃ crystal, Li₂Mg (SiO₄) crystal, LiAlSiO crystal, and Li₂Si₂O₄ crystal, or may contain any one type as the main crystal. In addition, two or more types of solid solution crystals selected from the group consisting of Li₃PO₄, Li₄SiO₄, Li₂SiO₃. Li₂Mg (SiO₄), and Li₂Si₂O₄ may be used as the main crystal.

A crystallization rate of the present glass ceramic is preferably 5% or more, more preferably 10% or more, still more preferably 15% or more, and particularly preferably 20% or more in order to increase a mechanical strength.

An average particle size of precipitated crystals of the present glass ceramic is preferably 5 nm or more, and particularly preferably 10 nm or more in order to increase a strength. In addition, in order to increase transparency, the average particle size is preferably 80 nm or less, more preferably 60 nm or less, still more preferably 50 nm or less, particularly preferably 40 nm or less, and most preferably 30 nm or less. The average particle size of the precipitated crystals is determined from a transmission electron microscope (TEM) image.

### <<Glass Composition>

The present glass ceramic preferably includes, in terms of mol % based on oxides:
40% to 70% of SiO₂,
10% to 35% of Li₂O,
4% to 15% of Al₂O₃,
0.5% to 5% of P₂O₅,
0% to 5% of ZrO₂,
0% to 10% of B₂O₃,
0% to 3% of Na₂O,
0% to 2% of K₂O,
0% to 4% of SnO₂, and
0% to 10% of MgO.

In addition, a total amount of SiO₂, Al₂O₃, P₂O₅, and B₂O₃ of the present glass ceramic is preferably 60% to 80% in terms of mol % based on oxides. SiO₂, Al₂O₃, P₂O₅, and B₂O₃ are glass network forming components (hereinafter, also abbreviated as NWF). When the total amount of NWF is large, the strength of the glass is increased. Therefore, the total amount of NWF is preferably 60% or more, more preferably 63% or more, and particularly preferably 65% or more, in order to increase a fracture toughness value of the glass ceramic. On the other hand, from the viewpoint of manufacturability such as preventing a melting temperature from becoming too high, the total amount of NWF is preferably 80% or less, more preferably 75% or less, and still more preferably 70% or less.

In the present glass ceramic, a ratio of a total amount of Li₂O, Na₂O, and K₂O to the total amount of NWF, that is, the total amount of SiO₂, Al₂O₃, P₂O₅, and B₂O₃ is preferably 0.20 to 0.60.

Li₂O, Na₂O, and K₂O are network modifiers, and lowering the ratio of network modifiers to NWF increases a void in a network and thus improves impact resistance. Therefore, the ratio of the total amount of Li₂O, Na₂O, and K₂O to the total amount of NWF is preferably 0.60 or less, more preferably 0.55 or less, and particularly preferably 0.50 or less. On the other hand, Li₂O, Na₂O, and K₂O are components necessary for chemical strengthening, and the ratio of the total amount of Li₂O, Na₂O, and K₂O to the total amount of NWF is preferably 0.20 or more, more preferably 0.25 or more, and particularly preferably 0.30 or more in order to improve chemical strengthening properties.

Hereinafter, the glass composition will be described.

SiO₂ is a component for forming a glass network structure. In addition, SiO₂ is a component that increases chemical durability, and a content thereof is preferably 40% or more, more preferably 45% or more, still more preferably 48% or more, even more preferably 50% or more, particularly preferably 52% or more, and extremely preferably 54% or more. On the other hand, in order to improve meltability, the content of SiO₂ is preferably 70% or less, more preferably 68% or less, still more preferably 66% or less, and particularly preferably 64% or less.

Al₂O₃ is a component that increases a surface compressive stress due to chemical strengthening when the chemical strengthening is performed. A content of Al₂O₃ is preferably 4% or more, more preferably 5% or more, still more preferably 5.5% or more, even more preferably 6% or more, particularly preferably 6.5% or more, and most preferably 7% or more. On the other hand, the content of Al₂O₃ is preferably 15% or less, more preferably 12% or less, still more preferably 10% or less, particularly preferably 9% or less, and most preferably 8% or less in order to prevent the glass from having an excessively high devitrification temperature.

Li₂O is a component for forming a surface compressive stress by ion exchange, and is a constituent component of the main crystal, and thus is essential. A content of Li₂O is preferably 10% or more, more preferably 14% or more, still more preferably 20% or more, and particularly preferably 22% or more. On the other hand, in order to stabilize the glass, the content of Li₂O is preferably 35% or less, more preferably 32% or less, and still more preferably 30% or less.

Na₂O is a component that improves meltability of the glass. Na₂O is not essential, but when Na₂O is contained, a content thereof is preferably 0.5% or more, more preferably 1% or more, and particularly preferably 2% or more. When the content of Na₂O is too large, crystals such as Li₃PO₄, which are the main crystal, are less likely to precipitate, or chemical strengthening properties deteriorate, and thus the content of Na₂O is preferably 3% or less, more preferably 2% or less, and still more preferably 1% or less.

K₂O, like Na₂O, is a component that lowers a melting temperature of the glass and may be contained. When K₂O is contained, a content thereof is preferably 0.5% or more, more preferably 1% or more, and still more preferably 1.5% or more. When the content of K₂O is too large, the chemical strengthening properties are reduced, or the chemical durability is reduced, and thus the content is preferably 2% or less, and most preferably 1% or less.

A total content of Na₂O and K₂O, Na₂O+K₂O, is preferably 1% or more, and more preferably 2% or more in order to improve meltability of a glass raw material.

In addition, a ratio of the content of K₂O to the total content of Li₂O, Na₂O, and K₂O (hereinafter, referred to as R₂O), that is K₂O/R₂O, is preferably 0.2 or less because the chemical strengthening properties can be increased, and the chemical durability can be increased. K₂O/R₂O is more preferably 0.15 or less, and still more preferably 0.10 or less.

R₂O is preferably 10% or more, more preferably 15% or more, and still more preferably 20% or more. In addition, R₂O is preferably 35% or less, more preferably 29% or less, and still more preferably 26% or less.

P₂O₅ is a constituent component of Li₃PO₄ crystal and is essential. In order to promote crystallization, a content of P₂O₅ is preferably 0.5% or more, more preferably 1% or more, still more preferably 1.5% or more, particularly preferably 2% or more, and extremely preferably 2.5% or more. On the other hand, when the content of P₂O₅ is too large, phase separation is likely to occur during melting and acid resistance is remarkably lowered, and therefore, the content of P₂O₅ is preferably 5% or less, more preferably 4.8% or less, still more preferably 4.5% or less, and particularly preferably 4.2% or less.

ZrO₂ is a component for increasing a mechanical strength and chemical durability, and is preferably contained. A content of ZrO₂ is preferably 0% or more, more preferably 0.1% or more, and still more preferably 0.2% or more. On the other hand, in order to prevent devitrification during the melting, the content of ZrO₂ is preferably 5% or less, more preferably 4.5% or less, still more preferably 4% or less, and particularly preferably 3.5% or less.

In addition, in order to increase the chemical durability, ZrO₂/R₂O is preferably 0 or more, and more preferably 0.1 or more. In order to increase transparency after crystallization, ZrO₂/R₂O is preferably 0.6 or less, and more preferably 0.4 or less.

TiO₂ is a component capable of promoting the crystallization and may be contained. TiO₂ is not essential, but when TiO₂ is contained, a content thereof is preferably 0.2% or more, and more preferably 0.5% or more. On the other hand, in order to prevent the devitrification during the melting, the content of TiO₂ is preferably 4% or less, more preferably 2% or less, and still more preferably 1% or less.

SnO₂ has an effect of promoting formation of a crystal nucleus and may be contained. SnO₂ is not essential, but when SnO₂ is contained, a content thereof is preferably 0.5% or more, more preferably 1% or more, still more preferably 1.5% or more, and particularly preferably 2% or more. On the other hand, in order to prevent the devitrification during the melting, the content of SnO₂ is preferably 4% or less, and more preferably 3% or less.

Y₂O₃ is a component having an effect of preventing fragments from scattering when a chemically strengthened glass is broken in a case where the glass ceramic is chemically strengthened, and Y₂O₃ may be contained. A content of Y₂O₃ is preferably 1% or more, more preferably 1.5% or more, still more preferably 2% or more, particularly preferably 2.5% or more, and extremely preferably 3% or more. On the other hand, in order to prevent the devitrification during the melting, the content of Y₂O₃ is preferably 5% or less, and more preferably 4% or less.

B₂O₃ is a component that improves chipping resistance of the glass and improves the meltability, and may be contained. When B₂O₃ is contained, a content thereof is preferably 0.5% or more, more preferably 1% or more, and still more preferably 2% or more, in order to improve the meltability. On the other hand, when the content of B₂O₃ is too large, striae are generated during the melting or phase separation is likely to occur, and thus a quality of the glass is likely to be deteriorated, and therefore, the content is preferably 10% or less, more preferably 5% or less, still more preferably 4% or less, even more preferably 3% or less, and particularly preferably 2% or less.

BaO, SrO, MgO, CaO, and ZnO are components for improving the meltability of the glass, and may be contained. When these components are contained, a total content of BaO, SrO, MgO, CaO, and ZnO (hereinafter, referred to as BaO+SrO+MgO+CaO+ZnO) is preferably 0.5% or more, more preferably 1% or more, still more preferably 1.5% or more, and particularly preferably 2% or more. On the other hand, when the total content of these components is too large, an ion exchange rate is decreased, and thus BaO+SrO+MgO+CaO+ZnO is preferably 10% or less, more preferably 8% or less, still more preferably 6% or less, even more preferably 5% or less, and particularly preferably 4% or less.

Among these, BaO, SrO, and ZnO may be contained in order to improve a refractive index of a residual glass to be close to a precipitated crystal phase, thereby improving a light transmittance of the glass ceramic to decrease a haze value. In this case, a total content of BaO, SrO, and ZnO (hereinafter, referred to as BaO+SrO+ZnO) is preferably 0.3% or more, more preferably 0.5% or more, still more preferably 0.7% or more, and particularly preferably 1% or more. On the other hand, these components may reduce the ion exchange rate. In order to improve the chemical strengthening properties, BaO+SrO+ZnO is preferably 2.5% or less, more preferably 2% or less, still more preferably 1.7% or less, and particularly preferably 1.5% or less.

When MgO is contained, MgO is necessary to precipitate Li₂Mg (SiO₄) crystals, and thus a content of MgO is preferably 0.1% or more, and more preferably 4.0% or more. In addition, in order to improve the chemical strengthening properties, the content of MgO is preferably 10% or less, and more preferably 5.4% or less.

La₂O₃, Nb₂O₅, and Ta₂O₅ are all components that prevent fragments from scattering when the chemically strengthened glass is broken, and may be contained in order to increase the refractive index. When these components are contained, a total content of La₂O₃, Nb₂O₅, and Ta₂O₅ (hereinafter, referred to as La₂O₃+Nb₂O₅+Ta₂O₅) is preferably 0.5% or more, more preferably 1% or more, still more preferably 1.5% or more, and particularly preferably 2% or more. In addition, in order to prevent the devitrification of the glass during the melting, La₂O₃+Nb₂O₅+Ta₂O₅ is preferably 4% or less, more preferably 3% or less, still more preferably 2% or less, and particularly preferably 1% or less.

CeO₂ may be contained. CeO₂ may prevent coloring by oxidizing the glass. When CeO₂ is contained, a content thereof is preferably 0.03% or more, more preferably 0.05% or more, and still more preferably 0.07% or more. The content of CeO₂ is preferably 1.5% or less, and more preferably 1.0% or less, in order to increase the transparency.

When the glass is colored and used, coloring components may be added within a range that does not impede achievement of desired chemical strengthening properties. Examples of the coloring component include Co₃O₄, MnO₂, Fe₂O₃, NiO, CuO, Cr₂O₃, V₂O₅, Bi₂O₃, SeO₂, Er₂O₃ and Nd₂O₃.

A total content of the coloring components is preferably in a range of 1% or less. In a case where it is desired to further increase a visible light transmittance of the glass, these components are preferably not substantially contained.

SO₃, a chloride, and a fluoride may be appropriately contained as a refining agent or the like during the melting of the glass. As₂O₃ is preferably not contained. When Sb₂O₃ is contained, a content thereof is preferably 0.3% or less, more preferably 0.1% or less, and most preferably Sb₂O₃ is not contained.

### <<Chemically Strengthened Glass>

The glass according to the present invention may be a chemically strengthened glass (hereinafter, also abbreviated as a “present strengthened glass”) by being subjected to a chemical strengthening treatment. A retardation value of the present strengthened glass is basically the same as that of the glass before chemical strengthening. An adhesive strength of the present strengthened glass with a carbon member at a central portion in a sheet thickness direction is equivalent to the adhesive strength of the glass before chemical strengthening.

The present strengthened glass preferably has a surface compressive stress value (CS₀) of 400 MPa or more because the present strengthened glass is less likely to crack due to deformation such as deflection. CS₀ is more preferably 500 MPa or more, and still more preferably 600 MPa or more. The strength increases as CS₀ increases, but when CS₀ is too large, severe fracture may occur at the time of cracking, and thus CS₀ is preferably 1200 MPa or less, and more preferably 1000 MPa or less.

The present strengthened glass preferably has a DOL of 70 μm or more because the present strengthened glass is less likely to crack even when a surface is scratched. The DOL is more preferably 100 μm or more. As the DOL increases, the glass is less likely to crack even when scratches are generated. However, in the chemically strengthened glass, a tensile stress is generated in the inside in accordance with a compressive stress formed in the vicinity of the surface, and thus it is not possible to extremely increase the DOL. The DOL is preferably t/4 or less, and more preferably t/5 or less, with respect to a thickness t of the strengthened glass. The DOL is preferably 200 μm or less, and more preferably 180 μm or less in order to shorten a time required for chemical strengthening.

The present strengthened glass preferably has a CT of 110 MPa or less because scattering of fragments is prevented when the chemically strengthened glass is broken. The CT is more preferably 100 MPa or less, and still more preferably 90 MPa or less. On the other hand, when the CT is reduced, the surface compressive stress is small, and there is a tendency that it is difficult to obtain a sufficient strength. Therefore, the CT is preferably 50 MPa or more, more preferably 55 MPa or more, and still more preferably 60 MPa or more.

A base composition of the present strengthened glass as a whole has a composition similar to that of the glass before strengthening, except for a case where an extreme ion exchange treatment is performed. In particular, a composition of the deepest portion from the glass surface is the same as the composition of the glass before chemical strengthening, except for the case where the extreme ion exchange treatment is performed. In the present description, the “base composition of the chemically strengthened glass” refers to a composition before chemical strengthening.

### <<Usage>>

The three-dimensionally shaped glass according to the present invention is also useful as a cover glass used in an electronic device such as a mobile device such as a mobile phone or a smart phone. Furthermore, the three-dimensionally shaped glass is also useful for a cover glass of an electronic device such as a television, a personal computer, and a touch panel, an elevator wall surface, or a wall surface (full-screen display) of a construction such as a house and a building, which are not intended to be carried. The three-dimensionally shaped glass is also useful as a building material such as a window glass, a table top, an interior of an automobile, an airplane, or the like, and a cover glass thereof, or a casing having a curved surface shape.

### <Method for Producing Three-Dimensionally Shaped Glass Ceramic>

A method for producing a three-dimensionally shaped glass ceramic in the present embodiment preferably includes a step of preparing a glass ceramic and a step of press molding the glass ceramic.

### <<Process of Preparing Glass Ceramic>

The glass ceramic is obtained by subjecting an amorphous glass to a heat treatment to precipitate crystal particles from an amorphous portion. The amorphous glass can be produced by a usual method. For example, raw materials of components of the glass are blended, and then heated and melted in a glass melting furnace. Thereafter, the glass is homogenized by a known method and molded into a desired shape such as a glass sheet, followed by being annealed. In a case of molding the glass sheet, the glass may be molded into a sheet shape by a float method, a press method, a down draw method, or the like. Alternatively, the molten glass may be molded into a block shape, followed by being annealed, and cut into a sheet shape.

Examples of a method of mixing particles in the amorphous portion of the glass include a method of obtaining the glass ceramic by subjecting the amorphous glass to the heat treatment by a method to be described later, and a method of mixing desired particles when the raw materials of the glass are heated and melted in the glass melting furnace in the production of the amorphous glass.

The heat treatment for crystallization of the amorphous glass may be a two-stage heat treatment in which the glass is heated from room temperature to a first treatment temperature and is held for a certain period of time, and then is held for a certain period of time at a second treatment temperature that is higher than the first treatment temperature. Alternatively, the heat treatment may be a one-stage heat treatment in which the glass is held at a specific treatment temperature and then cooled to room temperature.

In a case of the two-stage heat treatment, the first treatment temperature is preferably in a temperature range where a crystal nucleus growth rate is high in the glass composition, and the second treatment temperature is preferably in a temperature range where a crystal nucleus growth rate is high in the glass composition. A holding time at the first treatment temperature is preferably kept long so that a sufficient number of crystal nuclei are generated. By generating a large number of crystal nuclei, a size of each crystal is reduced, and a glass ceramic having high transparency is obtained.

In the case of the two-stage treatment, for example, the glass is held at the first treatment temperature of 500° ° C. to 700° C. for 1 hour to 6 hours, and then held at the second treatment temperature of 600° ° C. to 800° C. for 1 hour to 6 hours. In a case of the one-stage treatment, for example, the glass is held at 500° ° C. to 800° ° C. for 1 hour to 6 hours.

The glass ceramic obtained by the above procedure is subjected to grinding and polishing if necessary to form a glass ceramic sheet. If the glass ceramic sheet is cut into a predetermined shape and size or subjected to chamfering, it is preferable to perform cutting or chamfering before the chemical strengthening treatment is performed because a compressive stress layer is also formed on an end surface by the subsequent chemical strengthening treatment.

In the method for producing the three-dimensionally shaped glass ceramic according to the present embodiment, a timing for crystallizing the amorphous glass to obtain the glass ceramic may be before the press molding or at the same time as the press molding, but from the viewpoint of preventing the crystallization during the molding, the timing is preferably before the press molding.

### <<Press Molding Process>

The press molding is a method in which a glass sheet is placed between an upper mold and a lower mold of a mold including the upper mold and the lower mold, the glass sheet is heated, and a press load is applied between the upper and lower molds to bend the glass sheet into a predetermined shape.

In the manufacturing method of the present embodiment, by performing the bending by the press molding, a temperature rise of the glass during the bending can be controlled, and an adhesive force of the glass with the mold can be reduced. Examples of a heating method at the time of press molding include a method in which heating is performed by bringing a heater plate held at a high temperature into contact with upper and lower mold surfaces, and a method in which heating is performed by disposing a heater around a mold.

A method for producing the three-dimensionally shaped glass ceramic according to an embodiment of the present invention is a method for producing a glass ceramic having a three-dimensional shape, the method including: press molding a glass ceramic with a mold, in which the glass ceramic has an adhesive strength with a carbon member of 140 [N] or less where the adhesive strength is measured by the following measurement method when an equilibrium viscosity is 1.0×10⁹ [dPa·S].

### (Method)

The glass ceramic is heated from room temperature to a set temperature at 100° ° C./min, and the following carbon member is pressed at 32 N on the glass ceramic which is allowed to stand for 10 minutes after reaching the set temperature, and then held for 180 seconds. Thereafter, an adhesive force generated when the carbon member is pulled up from the glass ceramic at 10 mm/min is measured by a load cell, and is defined as an adhesive strength.

Measuring device: light-condensing heating-type high-temperature observation tensile and compression tester

Size of glass ceramic: 9.2×9.2×2 [mm]

Carbon member: CIP carbon

Diameter of contact surface of carbon member with glass ceramic: diameter 9 [mm]

Roughness of contact surface of carbon member with glass ceramic: arithmetic average roughness Ra in accordance with JIS B0601 (2013) is 1.1 [μm], and arithmetic average waviness Wa is 0.08 [μm]

Oxygen concentration during measurement: 100 [ppm] or less

Examples of the load cell used for the measurement include TCLZ-100NA (manufactured by Tokyo Measuring Instruments Laboratory Co., Ltd.).

The set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

When the adhesive strength is 140 [N] or less, the retardation of the glass having a three-dimensional shape can be reduced, and cracking and distortion can be significantly prevented. From the viewpoint of preventing the cracking and the distortion of the three-dimensionally shaped glass, the adhesive strength is preferably 130 [N] or less, more preferably 120 [N] or less, and still more preferably 110 [N] or less. In addition, from the viewpoint of moldability, the adhesive strength is usually preferably 0.01 [N] or more.

A magnitude of a press load is not particularly limited, but is, for example, preferably 8 kN or less, more preferably 6 kN or less, and still more preferably 2 kN or less. The carbon member contains carbon as a main component, and the carbon as a main component usually means that the carbon is contained in an amount of 99 mass % or more, preferably 99.9 mass % or more, more preferably 99.99 mass % or more, and particularly preferably 100 mass %.

In the present embodiment, in the press molding, when a press load is applied to the glass, a surface pressure of a contact surface of the mold with respect to the glass at the equilibrium viscosity of 1.0×10⁹ [dPa·S] is preferably 10.0 MPa or less, more preferably 5.0 MPa or less, and still more preferably 1.0 MPa or less. From the viewpoint of the moldability, a lower limit of the surface pressure is usually preferably 0.01 MPa or more.

An equilibrium viscosity of a glass central portion when the press load is applied to the glass is preferably 1.0×10¹⁴ [dPa·S] or more and 1.0×10⁷ [dPa·S] or less, more preferably 1.0×10^{13.5} [dPa·S] or more and 1.0×10^{7.5} [dPa·S] or less, and still more preferably 1.0×10¹³ [dPa·S] or more and 1.0×10⁸ [dPa·S] or less.

A rate of change in crystallinity of the glass ceramic before and after the press molding is preferably 10% or less, more preferably 5% or less, and still more preferably 1% or less from the viewpoint of preventing a change in physical properties before and after the molding. The rate of change in the crystallinity before and after the molding of the glass ceramic can be adjusted by changing a molding temperature and a molding time.

In the above molding process, the press molding may be performed simultaneously with a heating treatment. Examples of the heat treatment include a radiation or contact heat treatment. When there is a temperature difference between a bent portion and a flat portion, local heating may be performed, but the temperature difference may not be provided.

### <<Chemical Strengthening Treatment Process>

The method for producing the three-dimensionally shaped glass ceramic in the present embodiment may include a chemical strengthening treatment step. In the present embodiment, when the chemical strengthening treatment is performed, the chemical strengthening treatment is preferably performed after the above press molding process.

In the chemical strengthening treatment, typically, the glass is brought into contact with a metal salt such as potassium nitrate, which contains metal ions having a large ion radius such as Na ions or K ions, by a method such as immersing the glass in a molten solution of the metal salt. Accordingly, metal ions having a small ionic radius in the glass are substituted with the metal ions having a large ionic radius, and ion exchange is performed. In the ion exchange, for example, Li ions are substituted with Na ions or K ions, and Na ions are substituted with K ions.

In order to increase a rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

Examples of a molten salt for performing the chemical strengthening treatment include a nitrate, a sulfate, a carbonate, and a chloride. Among these, examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. These molten salts may be used alone or in combination.

As treatment conditions of the chemical strengthening treatment, a time, a temperature, and the like can be selected in consideration of a glass composition, a type of the molten salt, and the like. For example, the glass is subjected to a chemical strengthening treatment at preferably 450° C. or less for preferably 1 hour or less. Specifically, for example, a treatment of immersion in a molten salt (for example, a mixed salt of lithium nitrate and sodium nitrate) containing 0.3 mass % of Li and 99.7 mass % of Na at preferably 450° ° C. for preferably about 0.5 hours is exemplified.

The chemical strengthening treatment may be, for example, two-stage ion exchange as follows. First, the present glass ceramic is immersed in a metal salt (for example, sodium nitrate) containing Na ions at preferably about 350° ° C. to 500° ° C. for preferably about 0.1 hours to 10 hours. This causes ion exchange between Li ions in the glass ceramic and Na ions in the metal salt, thereby forming a relatively deep compressive stress layer.

Next, the present glass ceramic is immersed in a metal salt, for example, potassium nitrate, which contains K ions at preferably about 350° C. to 500° C. for preferably about 0.1 hours to 10 hours. Accordingly, a large compressive stress is generated in a portion of the compressive stress layer formed in the previous process, for example, within a depth of about 10 μm. According to such a two-stage treatment, a stress profile having a large surface compressive stress value is easily obtained.

### EXAMPLES

Hereinafter, the present invention will be described with reference to Examples, but the present invention is not limited thereto. In tables, a blank indicates that measurement was not performed.

### [Evaluation Method]

### (Specific Gravity ρ)

A specific gravity of each glass was measured by Archimedes method. Results are shown in “ρ (g/cm³)” in Table 1.

### (Glass Transition Point Tg)

The glass was pulverized using an agate mortar, about 80 mg of powder was put into a platinum cell and heated from room temperature to 1100° C. at a heating rate of 10/min, a DSC curve was measured using a differential scanning calorimeter (DSC3300SA manufactured by Bruker Corporation), and a result of determining a glass transition point Tg is shown in “Tg” of Table 1.

### (Haze Value)

A haze value [unit: %] of the glass under a C light source was measured using a haze meter (HZ-V3, manufactured by Suga Test Instruments Co., Ltd.). Results are shown in “Haze (%)” in Table 1.

### (Young's Modulus E)

Young's modulus of the glass was measured by an ultrasonic method. Results are shown in “E (GPa)” in Table 1.

### (Fracture Toughness Value Kc)

A fracture toughness value of the glass was measured by an IF method in accordance with JIS R1607:2015. Results are shown in “Kc (MPa·m^{1/2})” in Table 1.

### (X-Ray Diffraction: Precipitated Crystals)

Powder X-ray diffraction of the glass was measured under the following conditions to identify precipitated crystals. Results are shown in “Crystals” in Table 2.

Measuring device: Smart Lab manufactured by Rigaku Corporation

X-ray used: CuKα ray

Measurement range: 20=10° to 80°

Speed: 10°/min

Step: 0.02°

### (Retardation)

Retardation was measured using a birefringence measuring device by vertically irradiating one or more points on an arc of each round shape of the glass after molding with light having a wavelength of 543 nm, and a value was obtained by dividing a maximum retardation value by a sheet thickness. Results are shown in Table 2.

An equilibrium viscosity of the glass was measured under the following conditions.

Device: WRVM-313 manufactured by OPT Corporation

Sample: Φ10×6 mm

Measurement conditions: at 10° C./min from room temperature to (Tg−50)ºC, and a measurement temperature range of 5° C./min

### (Adhesive Strength)

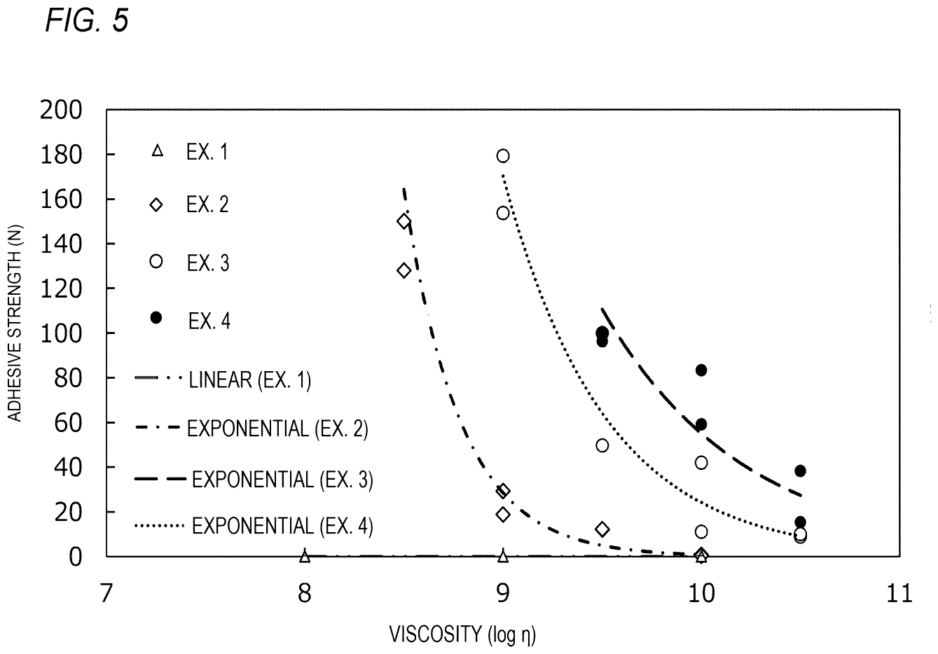

The glass ceramic was heated from room temperature to a set temperature at 100° C./min, and the following carbon member was pressed at 32 N on the glass ceramic which was allowed to stand for 10 minutes after reaching the set temperature, and then held for 180 seconds. Thereafter, an adhesive force generated when the carbon member was pulled up from the glass ceramic at 10 mm/min was measured by a load cell, and was defined as an adhesive strength. Results are shown in Table 2 and FIG. 5. For eight samples prepared, the set temperature was set to a temperature at which the equilibrium viscosity of the glass ceramic was 1.0×10⁹ [dPa·S], and an adhesive strength (N) with the carbon member when log η=9.0 d·Pas was plotted, and an average value was calculated.

Measuring device: light-condensing heating-type high-temperature observation tensile and compression tester

Size of glass ceramic: 9.2×9.2×2 [mm]

Carbon member: CIP carbon

Diameter of contact surface of carbon member with glass ceramic: diameter 9 [mm]

Roughness of contact surface of carbon member with glass ceramic: arithmetic average roughness Ra in accordance with JIS B0601 (2013) is 1.1 [μm], and arithmetic average waviness Wa is 0.08 [μm]

Oxygen concentration during measurement: 100 [ppm] or less

Load cell product number: TCLZ-100 NA (manufactured by Tokyo Measuring Instruments Laboratory Co., Ltd.)

The set temperature was a temperature at which the equilibrium viscosity of the glass ceramic was 1.0×10⁹ [dPa·S], and MC 4333 manufactured by Mechanical Carbon Industry Co., Ltd. was used as the CIP carbon.

In Table 2, “Entire surface devitrification” of Example 3 in the column of “Adhesive strength (N) with carbon member when log η=9.0 d·Pas” indicates that the adhesive strength could not be measured because the entire surface of the glass used for measuring the adhesive strength was devitrified. η indicates the equilibrium viscosity of the glass.

(Amount of Distortion after Molding)

A deviation of a glass shape from a design shape was evaluated by the following method.

A difference between an obtained molded product shape and the design shape was measured using a three-dimensional measuring device Atos manufactured by GOM. Results are shown in Table 2.

### (Yields)

The number of glasses that were not cracked through the molding process was divided by the number of glasses that were subjected to the molding process to calculate a ratio of occurrence of cracking, and yields were evaluated according to the following evaluation criteria. The occurrence of cracking in the glass was evaluated according to the following criteria.

Occurrence of cracking: cracks of 0.5 mm or more are present in a transmitted light image.

No occurrence of cracking: the above cracks are not present in the transmitted light image.

Visual observation results evaluated according to the following evaluation criteria are shown in Table 2.

◯: the ratio of occurrence of cracking is 51% or more

x: the ratio of occurrence of cracking is less than 51%<

### Production and Evaluation of Amorphous Glass>

Glass raw materials were blended in a manner of having a glass composition shown in Table 1 in terms of mass % based on oxides, and weighed out to give 800 g of glass. Next, the mixed glass raw materials were put in a platinum crucible, put into an electric furnace at 1400° C. to 1700° C., melted for about 5 hours, and then defoamed and homogenized.

The obtained molten glass was poured into a mold, held at a temperature of approximately 30° ° C. higher than a glass transition point for 1 hour, and then cooled to room temperature at a rate of 0.5° C./min, thereby obtaining a glass block. Table 1 shows results for evaluating the glass transition point, the specific gravity, the Young's modulus, and the fracture toughness value of the amorphous glass using a part of the obtained block.

In Table 1, “-” indicates no evaluation. In Table 1, R₂O represents a total content of Li₂O, Na₂O, and K₂O, and NWF represents a total content of SiO₂, Al₂O₃, P₂O₅, and B₂O₃.

TABLE 1

| | | Example 1 | Example 2 | Example 3 | Example 4 |
|---|---|---|---|---|---|
| Glass | SiO₂ | 70.1 | 61.0 | 50.0 | 51.2 |
| composition | Al₂O₃ | 4.3 | 5.0 | 5.0 | 5.0 |
| (mol %) | P₂O₅ | 0.8 | 2.0 | 2.3 | 2.3 |
| | B₂O₃ | 0.2 | 0.0 | 0.0 | 0.0 |
| | Li₂O | 21.4 | 21.0 | 34.1 | 34.1 |
| | Na₂O | 1.5 | 2.0 | 1.8 | 1.8 |
| | K₂O | 0.0 | 0.0 | 1.2 | 0.0 |
| | ZrO₂ | 1.7 | 3.0 | 4.5 | 4.5 |
| | SnO₂ | 0.0 | 0.0 | 0.0 | 0.0 |
| | Y₂O₃ | 0.0 | 1.0 | 1.0 | 1.0 |
| | R₂O | 0.0 | 0.0 | 37.1 | 0.0 |
| | CaO | 0.0 | 0.0 | 0.0 | 0.0 |
| | MgO | 0.0 | 5.0 | 0.0 | 0.0 |
| | NWF | 75 | 68 | 57 | 59 |
| | R₂O/(SiO₂ + Al₂O₃) | 0.31 | 0.35 | 0.67 | 0.64 |
| | R₂O/NWF | 0.30 | 0.34 | 0.65 | 0.61 |
| Glass | ρ (g/cm³) | 2.47 | 2.56 | 2.60 | 2.59 |
| properties | Tg (° C.) | — | 516 | 494 | — |
| | Haze (%) | ≤0.20 | 0.03 | 0.08 | 0.09 |
| | E (GPa) | 105 | 95 | 104 | 107 |
| | Kc (MPa · m^{1/2}) | 1.05 | 0.95 | 0.8 | 0.9 |

### <Crystallization Treatment and Evaluation on Glass Ceramic>

The obtained glass block was processed into a size of 70 mm×70 mm×1.5 mm, and then subjected to a heat treatment under conditions described in Table 2 to obtain a glass ceramic. In the column of “Heat treatment” showing crystallization conditions in Table 2, an upper row shows nucleation treatment conditions and a lower row shows crystal growth treatment conditions. For example, in a case where the upper row describes 550° C. and 2 h and the lower row describes 730° C. and 2 h, it means that the glass was held at 550° C. for 2 hours and then held at 730° C. for 2 hours.

The obtained glass ceramic was processed and mirror-polished to obtain a glass sheet having a thickness t of 0.55 mm. Under the conditions shown in Table 2, the sheet glass was bent and fit into a metal mold to be molded into a predetermined shape, thereby obtaining a curved glass having a curved surface shape.

A carbon concave mold and a carbon convex mold designed to mold a bent surface having a curvature radius of 6.0 mm and a bending depth of 4.0 mm were prepared, and the chamfered glass sheet was placed in the vicinity of a center of a contact surface of the concave mold with the glass.

As the carbon mold, ET-10 manufactured by IBIDEN CO., LTD. was used.

The glass sheet was preheated, deformed, and cooled in a state in which the concave mold and the convex mold on which the glass sheet was placed were respectively fixed to a lower shaft and an upper shaft of a molding device (glass element molding device: GMP-315V manufactured by Toshiba Machine Co., Ltd.).

In the preheating process, the glass sheet was heated from room temperature to 500° C. in 15 minutes. An equilibrium viscosity of the glass sheet at 500° C. is about 1016 dPa·s. Next, the glass sheet was heated from 500° ° C. to 630° C. in 5 minutes. An equilibrium viscosity of the glass sheet at 630° ° C. is about 10^{12.7} dPa·s.

While maintaining an equilibrium viscosity of a central portion of the glass at 10^{12.5} dPa·s to 10^{12.7} dPa·s, that is, while maintaining the temperature at 630° C. to 640° C., the convex mold was moved downward, and the concave mold was pressed at a maximum of 2000 N for 3 minutes. During this process, nitrogen gas was blown at a rate of 20 L/min through a through hole provided in the convex mold, so that the glass sheet is uniformly molded.

Next, the glass sheet was slowly cooled to 480° C. over 20 minutes. An equilibrium viscosity of the glass sheet at 480° C. is about 1017.5 dPa·s. Next, the convex mold was raised at 2 mm/sec and retracted, and the glass sheet was allowed to cool to room temperature.

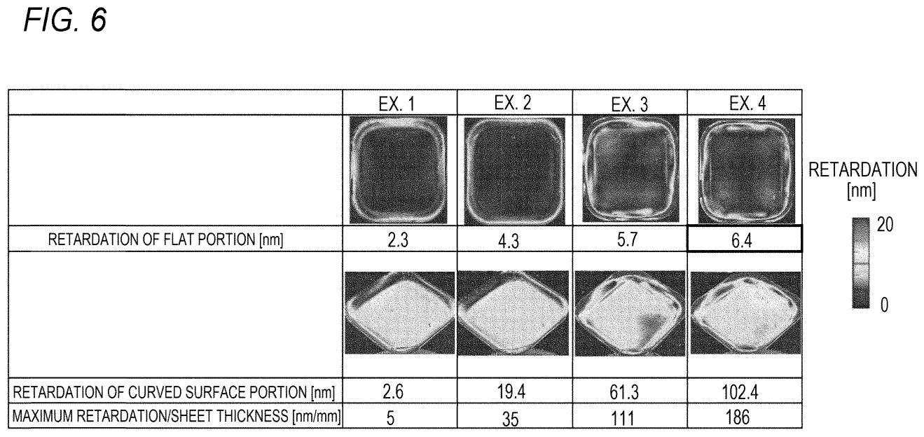

A part of the remaining glass ceramic was pulverized and used for analysis of precipitated crystals. Detected main crystals are shown in the column of crystals in Table 2. Li₃PO₄ and Li₄SiO₄ are difficult to be distinguished by powder X-ray diffraction, and thus are described together. Evaluation results of the glass ceramic are shown in Table 2, FIG. 5, and FIG. 6. “-” indicates no evaluation. Examples 1 and 2 are Examples, and Examples 3 and 4 are Comparative Examples. FIG. 5 shows an adhesive strength (N) with the carbon member when log η=9.0 d·Pas.

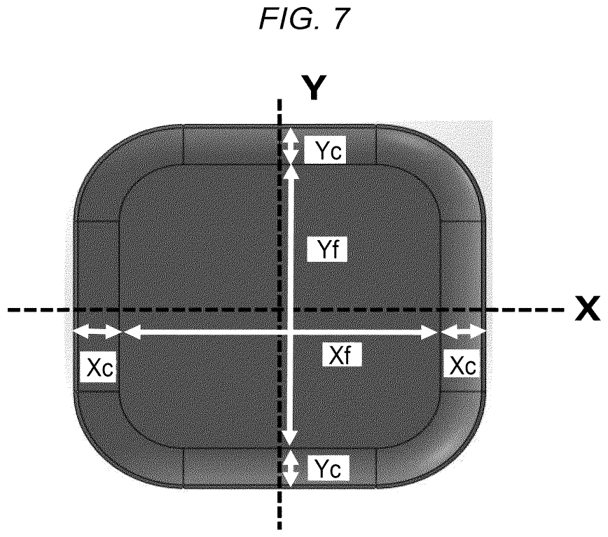

Table 3 shows results of measuring a curvature radius of the produced glass ceramic having a three-dimensional shape, using a three-dimensional measuring device Atos manufactured by GOM. A measurement value was calculated by obtaining cross-sectional data on center X and Y planes of a sample at a pitch of 0.1 mm from point cloud data obtained by measurement using the three-dimensional measuring device Atos, and approximating the cross-sectional data by a least square method of a circle. A correspondence between measurement points and the glass ceramic is shown in FIG. 7.

Xf: calculated by extracting a position of ±20 mm from a center of a sample at a maximum R (mm) measured at a flat portion in a short direction

Xc: calculated by extracting data from outside the range of ±20 mm from the center of the sample at a minimum R (mm) measured at a bent portion in the short direction

Yf: calculated by extracting a position of ±20 mm from the center of the sample at a maximum R (mm) measured at a flat portion in a longitudinal direction

Yc: calculated by extracting data from outside the range of ±20 mm from the center of the sample at a minimum R (mm) measured at a bent portion in the longitudinal direction

TABLE 2

| | Example 1 | Example 2 | Example 3 | Example 4 |
|---|---|---|---|---|
| Heat treatment in | 570° C. 4 h | 550° C. 2 h | 550° C. 2 h | 550° C. 2 h |
| crystallization | 740° C. 1 h | 750° C. 2 h | 730° C. 2 h | 710° C. 2 h |
| Presence or absence | Present | Present | Present | Present |
| of particles mixed in | | | | |
| amorphous portion | | | | |
| Diameter of at least one particle | 19 nm or more | 10 nm or more | 10 nm or more | 10 nm or more |
| Volume fraction of particles (%) | 80 | 20 | 40 | 40 |
| Crystals | LiAlSi₄O₁₀ | Li₃PO₄, Li₄SiO₄, | Li₂SiO₃ | Li₂SiO₃ |
| | Li₂Si₂O₅ | or solid solution | | Li₃PO₄ |
| | | thereof | | |
| Molding timing | After | After | After | After |
| | crystallization | crystallization | crystallization | crystallization |
| Molding conditions | 739° C. 3 min | 563° C. 3 min | 620° C. 3 min | 646° C. 3 min |
| Logarithm of equilibrium | Unknown | 13 | 12.7 | 12 |
| viscosity η of glass | | | | |
| during molding log η (d · Pas) | | | | |
| Maximum retardation/sheet | 5 | 35 | 111 | 186 |
| thickness (nm/mm) | | | | |
| Adhesive strength (N) with | 0 | 24.1 | Entire | 166.5 |
| carbon member when | | | surface | |
| log η = 9.0 d · Pas | | | devitrification | |
| Amount of distortion | 0.244 | 0.229 | 0.271 | 0.288 |
| after molding | | | | |
| Yields (%) | 100 | 100 | 50 | 50 |

TABLE 3

| Unit (mm) | Example 1 | Example 2 | Example 3 | Example 4 |
|---|---|---|---|---|
| Xf | 8939 | 2761 | 1323 | 7131 |
| Xc | 5.2 | 5.3 | 5.5 | 5.2 |
| Yf | 9128 | 7952 | 1425 | 6921 |
| Yc | 5.2 | 5.3 | 5.3 | 5.2 |

As shown in FIG. 6 and Table 2, it was found that in Examples 1 and 2, which are Examples, a value obtained by dividing a maximum value of retardation by a sheet thickness was small and the retardation in a three-dimensional shape was small as compared with Comparative Examples. As shown in FIG. 5, Examples 1 and 2, which are Working Examples, had a low adhesive strength with a carbon member as compared with Examples 3 and 4, which are Comparative Examples. Further, as shown in Table 2, in Examples 1 and 2, which are Working Examples, distortion after molding was prevented and yields were improved as compared with Comparative Examples.

As an example of a shape of the three-dimensionally shaped glass of the present invention shown in FIGS. 3A and 3B, it was confirmed that an average curvature radius in both Working Examples and Comparative Examples falls within a range of 5.0×10² mm or less for a minimum round shape and 1.0×10³ mm or more for a maximum round shape.

As described above, the followings are disclosed in the present description.

1. A glass ceramic having a three-dimensional shape including a plurality of round shapes including a minimum round shape having an average curvature radius of 5.0×10² mm or less and a maximum round shape having an average curvature radius of 1.0×10³ mm or more, in which
the glass ceramic has a sheet thickness t [mm], and a value obtained by dividing a maximum value of retardation [nm] measured by the following measurement method by the sheet thickness t [mm] is 50 [nm/mm] or less,
measurement method: retardation is measured using a birefringence measuring device by vertically irradiating one or more points on an arc of each of the round shapes with light having a wavelength of 543 nm.

2. The glass ceramic according to 1, in which
the value obtained by dividing the maximum value of the retardation [nm] by the sheet thickness t [mm] is 40 [nm/mm] or less.

3. The glass ceramic according to 1 or 2, in which
the value obtained by dividing the maximum value of the retardation [nm] by the sheet thickness t [mm] is 35 [nm/mm] or less.

4. A glass ceramic, in which
an adhesive strength with a carbon member is 140 [N] or less, where the adhesive strength is measured by the following method when an equilibrium viscosity of the glass ceramic is 1.0×10⁹ [dPa·S],

### (Measurement Method)

the glass ceramic is heated from room temperature to a set temperature at 100° C./min, allowed to stand for 10 minutes after reaching the set temperature, and the carbon member below is pressed at 32 N on the glass ceramic and then held for 180 seconds; thereafter, an adhesive force generated when the carbon member is pulled up from the glass ceramic at 10 mm/min is measured by a load cell, and is defined as an adhesive strength,
measuring device: light-condensing heating-type high-temperature observation tensile and compression tester,
size of glass ceramic: 9.2× 9.2×2 [mm],
carbon member: CIP carbon,
diameter of contact surface of carbon member with glass ceramic: diameter 9 [mm],
roughness of contact surface of carbon member with glass ceramic: arithmetic average roughness Ra in accordance with JIS B0601 (2013) is 1.1 [μm], and arithmetic average waviness Wa is 0.08 [μm],
oxygen concentration during measurement: 100 [ppm] or less,
the set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

5. The glass ceramic according to any one of 1 to 4, including as crystal particles:
at least one selected from the group consisting of Li₃PO₄ crystals, Li₄SiO₄ crystals, Li₂SiO₃ crystals, Li₂Mg (SiO₄) crystals, LiAlSiO crystals, and Li₂Si₂O₄ crystals.

6. The glass ceramic according to any one of 1 to 5, in which the glass ceramic is used as a cover glass.

7. A chemically strengthened glass obtained by chemically strengthening the glass ceramic according to any one of 1 to 5.

8. A method for producing a glass ceramic having a three-dimensional shape, the method including:
press molding a glass ceramic with a mold, in which
the glass ceramic has an adhesive strength with a carbon member of 140 [N] or less, where the adhesive strength is measured by the following method when an equilibrium viscosity of the glass ceramic is 1.0×10⁹ [dPa·S],

### (Measurement Method)

the glass ceramic is heated from room temperature to a set temperature at 100° C./min, allowed to stand for 10 minutes after reaching the set temperature, and the carbon member below is pressed at 32 N on the glass ceramic and then held for 180 seconds; thereafter, an adhesive force generated when the carbon member is pulled up from the glass ceramic at 10 mm/min is measured by a load cell, and is defined as an adhesive strength,
measuring device: light-condensing heating-type high-temperature observation tensile and compression tester,
size of glass ceramic: 9.2× 9.2×2 [mm],
carbon member: CIP carbon,
diameter of contact surface of carbon member with glass ceramic: diameter 9 [mm],
roughness of contact surface of carbon member with glass ceramic: arithmetic average roughness Ra in accordance with JIS B0601 (2013) is 1.1 [μm], and arithmetic average waviness Wa is 0.08 [μm],
oxygen concentration during measurement: 100 [ppm] or less,
the set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

Although the present invention has been described in detail with reference to specific aspects, it is apparent to those skilled in the art that various changes and modifications can be made without departing from the spirit and scope of the present invention. The present application is based on a Japanese patent application (Japanese Patent Application No. 2021-205528) filed on Dec. 17, 2021, the entire contents of which are incorporated herein by reference. All references cited herein are incorporated herein entirety.

### REFERENCE SIGNS LIST

100 three-dimensionally shaped glass
110 central portion
120 peripheral portion
11 table
12 glass ceramic
13, 15 holder
14 pressing portion
16 carbon member

1. A glass ceramic having a three-dimensional shape including a plurality of round shapes including a minimum round shape having an average curvature radius of 5.0×10² mm or less and a maximum round shape having an average curvature radius of 1.0×10³ mm or more, wherein
the glass ceramic has a sheet thickness t [mm], and a value obtained by dividing a maximum value of retardation [nm] measured by the following measurement method by the sheet thickness t [mm] is 50 [nm/mm] or less,
measurement method: retardation is measured using a birefringence measuring device by vertically irradiating one or more points on an arc of each of the round shapes with light having a wavelength of 543 nm.

2. The glass ceramic according to claim 1, wherein
the value obtained by dividing the maximum value of the retardation [nm] by the sheet thickness t [mm] is 40 [nm/mm] or less.

3. The glass ceramic according to claim 1, wherein
the value obtained by dividing the maximum value of the retardation [nm] by the sheet thickness t [mm] is 35 [nm/mm] or less.

4. A glass ceramic, wherein
an adhesive strength with a carbon member is 140 [N] or less, where the adhesive strength is measured by the following method when an equilibrium viscosity of the glass ceramic is 1.0×10⁹ [dPa·S],
(measurement method)
the glass ceramic is heated from room temperature to a set temperature at 100° C./min, allowed to stand for 10 minutes after reaching the set temperature, and the carbon member below is pressed at 32 N on the glass ceramic and then held for 180 seconds; thereafter, an adhesive force generated when the carbon member is pulled up from the glass ceramic at 10 mm/min is measured by a load cell, and is defined as an adhesive strength,
measuring device: light-condensing heating-type high-temperature observation tensile and compression tester,
size of glass ceramic: 9.2× 9.2×2 [mm],
carbon member: CIP carbon,
diameter of contact surface of carbon member with glass ceramic: diameter 9 [mm],
roughness of contact surface of carbon member with glass ceramic: arithmetic average roughness Ra in accordance with JIS B0601 (2013) is 1.1 [μm], and arithmetic average waviness Wa is 0.08 [μm],
oxygen concentration during measurement: 100 [ppm] or less,
the set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.

5. The glass ceramic according to claim 1, comprising as crystal particles:
at least one selected from the group consisting of Li₃PO₄ crystals, Li₄SiO₄ crystals, Li₂SiO₃ crystals, Li₂Mg (SiO₄) crystals, LiAlSiO crystals, and Li₂Si₂O₄ crystals.

6. The glass ceramic according to claim 1, wherein
the glass ceramic is used as a cover glass.

7. A chemically strengthened glass obtained by chemically strengthening the glass ceramic according to claim 1.

8. The glass ceramic according to claim 4, comprising as crystal particles:
at least one selected from the group consisting of Li₃PO₄ crystals, Li₄SiO₄ crystals, Li₂SiO₃ crystals, Li₂Mg (SiO₄) crystals, LiAlSiO crystals, and Li₂Si₂O₄ crystals.

9. The glass ceramic according to claim 4, wherein
the glass ceramic is used as a cover glass.

10. A chemically strengthened glass obtained by chemically strengthening the glass ceramic according to claim 4.

11. A method for producing a glass ceramic having a three-dimensional shape, the method comprising:
press molding a glass ceramic with a mold, wherein
the glass ceramic has an adhesive strength with a carbon member of 140 [N] or less, where the adhesive strength is measured by the following method when an equilibrium viscosity of the glass ceramic is 1.0×10⁹ [dPa·S],
(measurement method)
the glass ceramic is heated from room temperature to a set temperature at 100° C./min, allowed to stand for 10 minutes after reaching the set temperature, and the carbon member below is pressed at 32 N on the glass ceramic and then held for 180 seconds; thereafter, an adhesive force generated when the carbon member is pulled up from the glass ceramic at 10 mm/min is measured by a load cell, and is defined as an adhesive strength,
measuring device: light-condensing heating-type high-temperature observation tensile and compression tester,
size of glass ceramic: 9.2× 9.2×2 [mm],
carbon member: CIP carbon,
diameter of contact surface of carbon member with glass ceramic: diameter 9 [mm],
roughness of contact surface of carbon member with glass ceramic: arithmetic average roughness Ra in accordance with JIS B0601 (2013) is 1.1 [μm], and arithmetic average waviness Wa is 0.08 [μm],
oxygen concentration during measurement: 100 [ppm] or less,
the set temperature is a temperature at which the equilibrium viscosity of the glass ceramic is 1.0×10⁹ [dPa·S], and MC 4333 manufactured by Mechanical Carbon Industry Co., Ltd. is used as the CIP carbon.
